(19) United States
(12) Patent Application Publication
(10) Pub. No.: US 2016/0114201 A1
(43) Pub. Date: Apr. 28, 2016

(54) Connection System for a Roof Panel of a Thermoacoustic Protection Enclosure

(71) Applicant: GE Energy Products France SNC, Belfort (FR)

(72) Inventor: Christophe Bolle, Chalonvillars (FR)

(21) Appl. No.: 14/876,910

(22) Filed: Oct. 7, 2015

(30) Foreign Application Priority Data
Oct. 23, 2014 (FR) 1460186

(51) Int. Cl. A62C 3/00; E04D 13/00; E04B 1/94

(52) U.S. Cl. CPC A62C 3/00; E04B 1/941; E04D 13/00

(57) ABSTRACT

This roof panel connection system of a thermoacoustic protection enclosure may include, for each roof panel, a flexible pipe, one end of which has a first connector for its connection to a water supply line and the other end with a second connector for its connection to a water distribution system, a protection rail to be mounted on an external face of the panel and delimiting a slot to receive the flexible pipe, and a mechanical protection part for the connecting device.

### TECHNICAL FIELD

Generally speaking, the present application relates to the thermoacoustic protection of power machines such as gas turbines, generators, and auxiliary equipment. More particularly, the present application relates to thermoacoustic protection enclosures for such power machines and to fire protection systems installed in such protection enclosures.

### BACKGROUND OF THE INVENTION

During the operation of power machines, fuel leaks may occur at, for example, the fuel inlet pipe flanges or the connection points to the machine. When the fuel is a pressurized oil, the fuel fluid may create a spray such that fuel ponds may form in the lower part of the machine. In the present state of the art, thermoacoustic protection enclosures based on the use of carbon dioxide may be considered advantageous as compared to systems based on the use of a water mist that are commonly used for the protection of buildings and public places. In fact, applying water directly to the hot sections of a turbine with no thermal protection may be considered dangerous, at least as long as the machine is not shut down. Moreover, the turbines blades may be severely damaged if the turbine casing shrinks due to rapid cooling.

The use of a water mist, however, does provide certain advantages as compared to systems based on the use of carbon dioxide or, generally, an inert gas. Indeed, water also is inert and the latent evaporation heat of water is relatively high such that water evaporates at a relatively low temperature. When water evaporates, the volume may expand to about 1700 times the initial volume. Moreover, water droplets are highly dynamic so as to promote mixing and evaporation. In fact, a water mist diffuser may allow for hundreds of water micro-droplets to be generated, thereby increasing the heat transfer exchange area.

The use of a water mist also may be advantageous to the extent that when a mist is formed in an enclosed compartment, about 90% of the water volume may be released in the form of micro-droplets with a diameter of less than about 90 microns. The droplets may rapidly descend in the compartment and recover the heat from a possible fire and from smoke by conduction, convection, and radiation. The water may be almost instantly converted into steam, thereby blocking the supply of oxygen close to the flame and moistening the fuel so as to prevent the fire from propagating. Moreover, a water mist simultaneously may acts on multiple combustion parameters. First of all, the mist may act on cooling of the flame and the fuel. This cooling contributes to the quenching of the flame and acts on the isolation of the flame from the oxygen. The water mist also permits attenuation of the thermal radiation.

As regards to thermoacoustic protection enclosures, existing regulations may impose a certain number of design parameters. These parameters may impact the number and location of injection nozzles in the ceiling of the enclosures and their spacing from the walls so as to ensure the effectiveness of the mist in relation to the configuration of the equipment.

In this respect, reference may be made to document EP 1 078 653 that describes a fire protection system for gas turbines that contains supply pipes with water injection nozzles arranged on either side of the combustion chamber of the turbine so as to allow water to be sprayed around the combustion chamber. During maintenance operations, however, and in particular when replacing components of the machine protected by the enclosure, such as the rotor, it may be necessary to remove the roof of the enclosure so as to facilitate access to the machine components.

In this respect, document FR 2 984 959 proposes to provide the enclosure with a roof having roof panels that rest on steel girders with the interposition of a seal. Compression of the seal is ensured by the weight of the roof panels and not by a clamping means. Removal and installation of the roof or part of the roof thus would not require clamp bolts for improved simplicity and speed.

Document US 2012/0073215 proposes to attach the roof panels to lateral walls by means of cooperating locks to fasten removably the roof panels either to the lateral walls or to another roof panel. When the roof panels have a water distribution system with associated spray nozzles, it may be necessary to provide for the rapid disconnection and reconnection of the distribution system to a water supply line during removal and installation of the panels. To this end, document US 2012/0097406 proposes the use of a clamp fastening system. Likewise, documents US 2011/0215566 and JP H 112 76628 recommend the use of a flexible pipe to connect the means for generating the water mist.

### SUMMARY OF THE INVENTION

In view of the foregoing, an object of the invention is a connection system, specifically for a water mist diffuser, that permits rapid and easy connection and disconnection from a water distribution system present in at least one roof panel equipped with spray nozzles. In addition, the invention provides for the protection of at least one connection of the distribution circuit to the water supply circuit accessible from the outside of the protection enclosure.

In a first aspect, an object of the invention is a connection system for at least one roof panel of a thermoacoustic protection enclosure for a power machine that has a distribution system with water injection nozzles. This system may include, for each roof panel, a flexible pipe with one end provided with a first connector to a water supply line and the other end with a second connector to the distribution system, and a protection rail to be mounted on an external face of the panel and delimiting a slot for receiving the flexible pipe. A mechanical protection part for the second connector also may be used.

In one implementation, the rail may be provided with straps for removably retaining the pipe in the slot. The straps may be, for example, rotationally mounted on the rail. According to another characteristic of the connection system, the protection part may feature a partition placed perpendicularly to the rail and an end plate extending perpendicularly to the partition. In one implementation, the device for connecting the flexible pipe may have a bent rigid tube integrated with the flexible pipe and including an end connector for connection to the distribution system, the end connector being protected by the partition and the end plate. The partition advantageously may have a retaining slot that receives the end of the flexible tube with a rigid tube. The slot may have a removable retaining bracket for the end of the flexible pipe with the rigid tube.

In a second aspect, another object of the invention is a roof panel for the thermoacoustic protection enclosure of a power machine. The roof panel may include a water distribution system equipped with nozzles mounted on a first face of the panel and meant to be directed towards the inside of the enclosure. The panel may include a connection system as defined above and mounted on a second face of the panel opposite the first face. Another object of the invention is a thermoacoustic enclosure for a power machine. The thermoacoustic enclosure may include a roof with at least one panel as defined above.

Other objectives, characteristics, and advantages of the invention will become apparent to one of ordinary skill in the art from the reading of the following description, which is provided only by way of example, and with reference to the attached drawings.

### BRIEF DESCRIPTION OF THE DRAWINGS

FIG. 1 is a perspective view of a thermoacoustic protection enclosure for a power generation machine.

FIG. 2 is a perspective view of the fire protection system of the enclosure of FIG. 1, showing the water distribution system.

FIG. 3 is a detailed view of the connection system of a roof panel of the enclosure of FIG. 1.

FIG. 4 is a larger scale view of the connection system of FIG. 3.

FIG. 5 is a detailed view of the mechanical protection part of the connection system of FIGS. 3 and 4.

### DETAILED DESCRIPTION

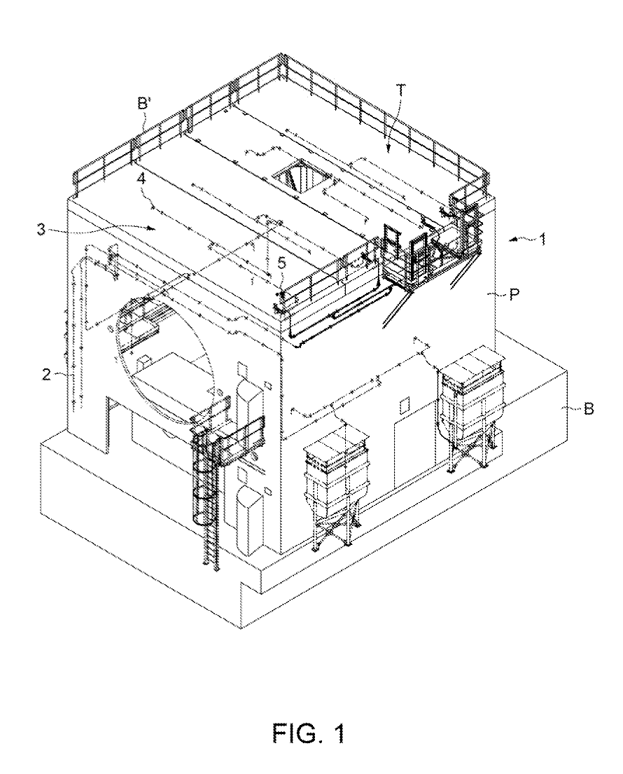

Reference will be made first to FIG. 1 that shows the overall structure of a thermoacoustic protection enclosure for a power generation machine, designated by the general numerical reference 1. In the implementation example considered herein, enclosure 1 is designed to ensure the protection of a gas turbine and/or auxiliary equipment. It is understood that the scope of the invention applies also to ensuring the protection of any other type of power machine such as a generator and the like.

Enclosure 1 may have a base B that supports a metal supporting structure (not shown). The base B may have any suitable size, shape, or configuration. A set of lateral panels, such as P, and a set of roof panels T, here four in total are shown, may be attached to the base B. Any number of the lateral panels P and the roof panels T may be used herein in any suitable size, shape, or configuration.

For the purpose of fire protection, the enclosure 1 may have a water distribution system 3 with associated injection nozzles 4 capable of generating a water mist within the internal volume of the enclosure 1. As is well known and as was previously indicated, a water mist is capable of simultaneously acting on multiple combustion parameters in the event of a fire. Notably by ensuring the cooling of the flame and the fuel, the quenching of the volume of the flame, the reduction of the oxygen concentration in the internal volume of the enclosure, and the attenuation of the thermal radiation.

The water distribution system 3 may be connected to one or more water supply lines 2, which in turn are connected to a supply system (not shown). Note that the water supply line or lines 2 may run on the inside of the enclosure 1 and, where they are connected to the water distribution system 3 on the outside of the enclosure 1, to allow them to be connected or disconnected on the outside.

As can be seen, to allow for easy access on the inside of the enclosure 1, in particular for maintenance operations, the roof of the enclosure may include multiple roof panels T, here four in total, that can be removed independently of each other. Each roof panel T may have its own water distribution system 3 with at least two associated nozzles 4. Thus, each panel T may have an independent water distribution system 3 and can be removed independently of the other panels T.

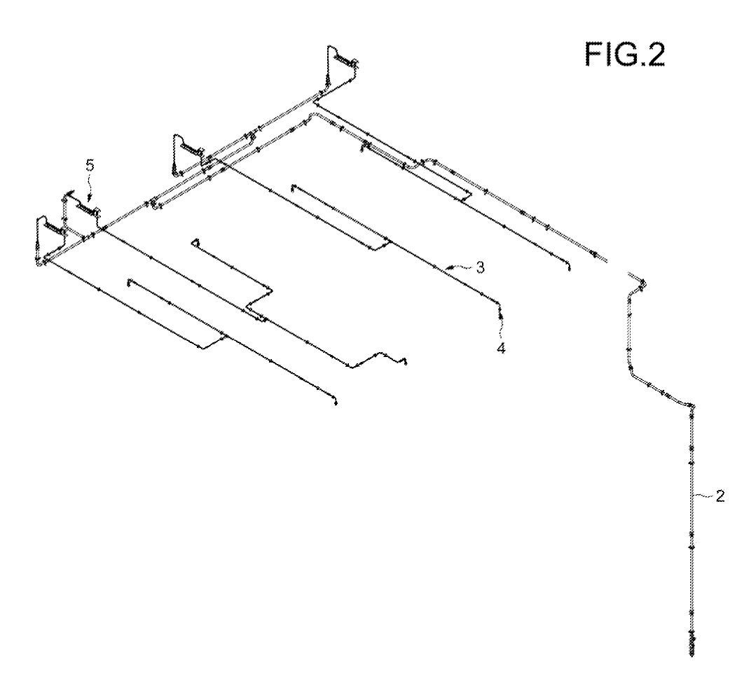

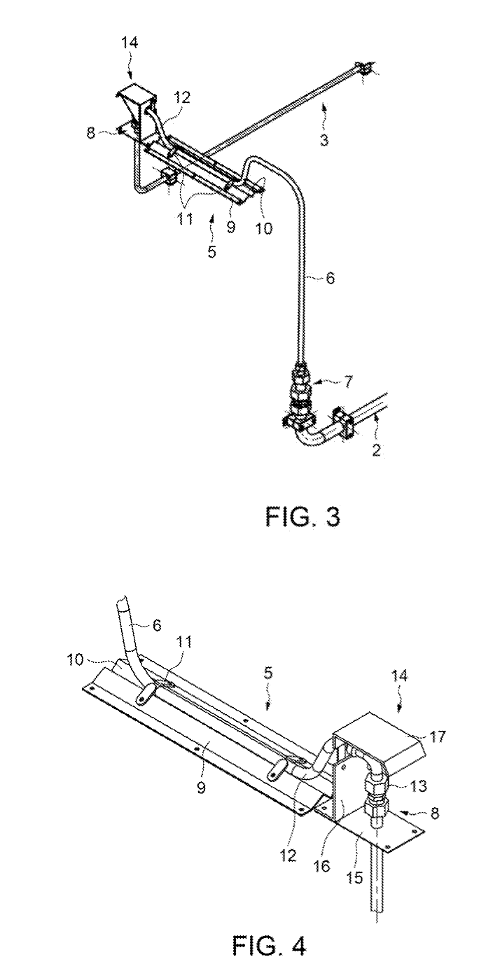

Referring to FIG. 2 that shows the water supply means of the enclosure 1. Specifically, a supply line 2 and, for each roof panel T, a water distribution system 3 with a number of associated nozzles 4. The water distribution system 3 may have any number of the nozzles 4 in any suitable size, shape, or configuration. One sees that the water distribution system 3 of each roof panel T is connected to the supply line 2 by means of a connection system 5. The connection system 5 allows for the selective and easy disconnection of each roof panel T from the water distribution system 3. Each connection system 5 may have a flexible pipe 6 as is shown in FIG. 3. One end of the flexible pipe 6 may be provided with a first connector 7 that cooperates with a matching connector of the supply line 2. As can be seen, the connectors may be of the threaded type and the like. On the opposite side, the flexible pipe 6 may have a second connector 8 for connecting to the water distribution system 3 present in each panel T. Similar to the first connector 7, the second connector 8 may be made, for example, from a threaded connector that cooperates with a matching connector of the water distribution system 3. The connection system 5, and the components thereof, may have any suitable size, shape, or configuration,

As previously indicated, where the water distribution system 3 is connected to the supply line 2, the supply line 2 may extend outside of the enclosure 1 while the water distribution system 3 may be mounted on the inside of the enclosure 1. The connecting system 5 thus may pass through the roof panel T for subsequent connection to the water distribution system 3. In other words, the flexible pipe 6 may run along a vertical lateral panel P of the enclosure 1, then above a safety barrier B′, and extend along the upper surface of the roof panel T up to where the connecting system 5 passes through the roof panel T for subsequent connection to the water distribution system 3.

The connection system 5 thus may include a rail 9 with a longitudinal slot 10 in which the flexible pipe 6 may be is inserted for the mechanical protection thereof. The slot 10 may prevent the flexible pipe 6 from being altered, for example, by an operator walking over the roof panel T. The slot 10 thus may be sufficiently deep to accommodate the entire flexible pipe 6. The rail 9 and the slot 10 may have any suitable size, shape, or configuration.

The rail 9 may be provided with a number of retaining straps 11, here four in total are shown, that ensure the removable retention of the pipe 6 in the slot 10. Any number of the retaining straps 11 may be used herein in any size, shape, or configuration. These retaining straps 11 are, for example, rotationally mounted on the rail 9 between a longitudinal position that provides access to the slot 10 and a transverse position that ensures the retention of the flexible pipe 6 in the slot 10. The retaining straps 11 thus prevent the flexible pipe 6 from being pulled out of the slot 10, for example, under the influence of the pressure that may be exerted by the water circulating in the flexible pipe 6 during operation.

Where the connection system 5 passes through the roof panel T, the connection system 5 may have a rigid bent tube 12. The rigid bent tube 12 may be welded or crimped, for example, to the flexible pipe 6. The bent tube 12 may be attached to the second connector 8. The bent tube 12 may have any suitable size, shape, or configuration. The bent tube 12 at one end of the flexible pipe 6 may be configured so as to position the second connector 8 in a vertical position for passing through the roof panel T. In fact, this vertical position may be an ergonomic position that facilitates the entry of the water distribution system 3 in the roof panel T on the one hand and the connection and the disconnection of the second connector 8 on the other hand.

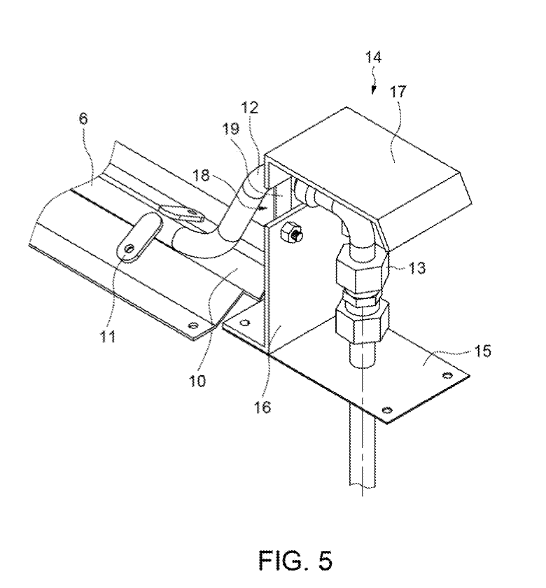

As also can be seen in FIGS. 3, 4 and 5, where the connection system 5 passes through the roof panel P, the connection system 5 may have a mechanical protection part 14. The mechanical protection part 14 may be mounted, for example, on the roof panel T. As can be seen, this mechanical protection part 14 may have a base 15 that is attached to the roof panel T, a partition wall 16 placed perpendicularly to the base 15 and the roof panel T and extending over a sufficient height to accommodate the bent tube 12, and an end plate 17 covering the area where it passes through the roof panel T and the second connector 8. This mechanical protection part 14 prevents the bent tube 12 and the second connector 8 from being altered by an operator walking over the roof or a falling object such as during maintenance operations on the roof of the enclosure 1. In fact, the rigid tube 12 and the second connector 8 may be protected vertically by the end plate 17 and laterally by the partition 16. The mechanical protection part 14, and the components thereof, may have any suitable size, shape, or configuration.

As can be seen, the partition wall 16 may have a retention slot 18 into which the end of the flexible pipe 6 with the bent tube 12 may be inserted. This retention slot 18 may have a pivoting retaining bracket 19 capable of removably retaining the end of the bent tube 12 in the retention slot 18. The flexible pipe 6 and the bent tube 12 thus remain protected by the mechanical protection part 14, even if a pressure load is applied in the flexible tube 6.

As was already indicated, each roof panel T with its water distribution system 3 and with at least two water nozzles 4 may be connected to the water supply line 2 by means of the connection system 5 as described in reference to FIGS. 3 to 5. Thus, during a maintenance operation, one simply has to unscrew the second connector 8 and release the bent tube 12 and the flexible pipe 6 from the slots 10 and 18 by moving the retaining straps 11 and the retaining brackets 19 to selectively remove each roof panel T. Of course, one could optionally provide a support for each flexible pipe 6 at a lateral panel P of the enclosure 1, for example in the form of a hook. Within the scope of the present invention, the connection system 5 with the flexible pipe 6 also can be used to connect the supply circuit to a water distribution system 3 provided with the nozzles 4 in the lateral panels P.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

I claim:

1. A system for the connection of at least one roof panel of a thermoacoustic protection enclosure for a power machine, comprising:
a water distribution system with a plurality of water injection nozzles;
a flexible pipe with a first connector for a water supply line and a second connector for the water distribution system;
a protection rail mounted to the panel and defining a slot therein; and
the flexible pipe positioned within the slot.

2. The system according to claim 1, wherein the protection rail comprises a plurality of straps for removable retention of the flexible pipe in the slot.

3. The system according to claim 2, wherein the plurality of straps are rotationally mounted on the protection rail.

4. The system according to claim 1, further comprising a protection part positioned about the second connector.

5. The system according to claim 4, wherein the protection part comprises a partition positioned perpendicularly to the protection rail and an end plate extending perpendicularly to the partition.

6. The system according to claim 5, wherein the second connector is protected by the partition and the end plate.

7. The system according to claim 5, further comprising a bent tube connected to the flexible pipe.

8. The system according to claim 7, wherein the partition comprises a retaining slot for the bent tube.

9. The system according to claim 7, wherein the protection part comprises a retaining bracket for the bent tube.

10. A roof panel of an enclosure for the thermoacoustic protection of a power machine, comprising:
a water distribution system;
a plurality of nozzles mounted on the panel and directed inside of the enclosure; and
a connection system mounted on the panel opposite the plurality of nozzles;
the connection system comprising a flexible pipe with a first connector for a water supply line and a second connector for the water distribution system;
a protection rail mounted on the panel and defining a slot therein; and
the flexible pipe positioned within the slot.

11. The roof panel according to claim 10, wherein the protection rail comprises a plurality of straps for removable retention of the flexible pipe in the slot.

12. The roof panel according to claim 10, further comprising a protection part positioned about the second connector.

13. The roof panel according to claim 12, wherein the protection part comprises a partition positioned perpendicularly to the protection rail and an end plate extending perpendicularly to the partition.

14. The roof panel according to claim 13, further comprising a bent tube connected to the flexible pipe.

15. The roof panel according to claim 14, wherein the partition comprises a retaining slot and a retaining bracket for the bent tube.
